(19) United States
(12) Patent Application Publication
(10) Pub. No.: US 2026/0115645 A1
(43) Pub. Date: Apr. 30, 2026

(54) MULTISTAGE UNIFORM TEMPERATURE PHASE CHANGE ABSORPTION TOWER FOR CAPTURING HIGH-CONCENTRATION CARBON DIOXIDE

(71) Applicant: Institute of Process Engineering, Chinese Academy of Sciences, Beijing (CN)

(72) Inventors: Tingyu ZHU, Beijing (CN); Wenqing XU, Beijing (CN); Yang YANG, Beijing (CN); Jun HE, Beijing (CN); Zanbu GENG, Beijing (CN)

(21) Appl. No.: 19/301,194

(22) Filed: Aug. 15, 2025

(30) Foreign Application Priority Data
Oct. 30, 2024 (CN) 202411527235.6

(51) Int. Cl. B01D 53/14; B01D 53/18

(52) U.S. Cl. CPC B01D 53/1475; B01D 53/1406; B01D 53/18; B01D 2257/504

(57) ABSTRACT

A multistage uniform temperature phase change absorption tower for capturing high-concentration carbon dioxide is provided, including an absorption tower, where the absorption tower is provided with multiple inlets, packing layers, and redistributors distributed from top to bottom; a phase separation tank, where a bottom of the phase separation tank is in communication with a bottom of the absorption tower through the pipelines, and a top of the phase separation tank is in communication with the third inlet and the first inlet through the pipelines; a heat exchanger, where the heat exchanger is in communication with the bottom of the phase separation tank through a rich liquid pump, and the heat exchanger is in communication with the fourth inlet and the second inlet through the pipelines; and a desorption tower, where the desorption tower is connected with a reboiler and connected with the heat exchanger through the pipelines.

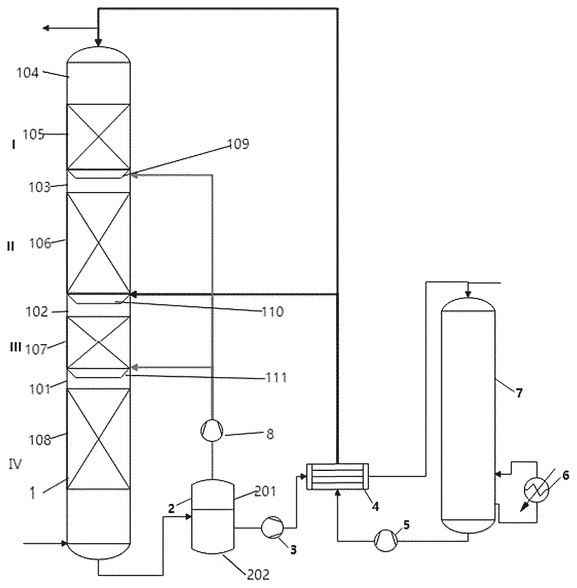

### CROSS-REFERENCE TO RELATED APPLICATIONS

This application claims priority to Chinese Patent Application No. 202411527235.6, filed on Oct. 30, 2024, the contents of which are hereby incorporated by reference.

### TECHNICAL FIELD

The present disclosure relates to the technical field of carbon dioxide emission reduction, and more particularly, to a multistage uniform temperature phase change absorption tower for capturing high-concentration carbon dioxide.

### BACKGROUND

As industrial development accelerates and fossil fuel consumption increases substantially, the atmospheric concentration of greenhouse gases, such as carbon dioxide, continues to rise, leading to intensifying environmental challenges including global warming and glacier melting. Among them, carbon dioxide is considered one of the primary culprits of climate change. To mitigate the negative impacts of climate change, carbon capture, utilization and storage (CCUS) is regarded as a technology with significant industrial application potential. Among various CCUS technologies, the organic amine absorption method in chemical absorption has been widely adopted due to its strong selectivity and broad applicability, and has become one of the mainstream technologies for post-combustion carbon dioxide capture.

However, conventional organic amine absorption methods face the issue of high regeneration energy consumption. To further reduce regeneration energy consumption, phase change absorption methods are produced, lowering energy consumption from approximately 4 gigajoules per ton (GJ/t) of CO₂ to around 2.4 GJ/t of CO₂. Yet, while reducing energy consumption, phase change absorption methods introduce heat release issues. The process of organic amine solutions absorbing CO₂ in the absorption tower is an exothermic reaction, and the generated heat transfers to the absorption liquid, causing the absorption liquid temperature to rise. The temperature rise of absorption liquid limits the driving force of the absorption process, reduces the CO₂ loading capacity of the absorption liquid, and accelerates the degradation of organic amines.

The severe heat release problem during the absorption process in phase change absorption methods has become an urgent industrial challenge. Maintaining the absorption tower solution at an appropriate temperature while ensuring capture efficiency is a crucial factor for advancing the technology.

### SUMMARY

The object of the present disclosure is to provide a multistage uniform temperature phase change absorption tower for capturing high-concentration carbon dioxide to solve the problems existing in the prior art. A multistage split-flow process is adopted to replace an inter-stage cooling process, and by adjusting the split-flow ratio, a uniform temperature distribution inside the entire absorption tower is achieved, thereby avoiding the occurrence of local hot spots.

To achieve the above object, the present disclosure provides the following technical solutions: the present disclosure provides a multistage uniform temperature phase change absorption tower for capturing high-concentration carbon dioxide, including: an absorption tower, where the absorption tower is provided with multiple inlets, packing layers, and redistributors distributed from top to bottom, the inlets are sequentially a fourth inlet, a third inlet, a second inlet and a first inlet from top to bottom, the packing layers are sequentially an I-stage packing layer, a II-stage packing layer, a III-stage packing layer and a IV-stage packing layer from top to bottom, and the redistributors are sequentially a first redistributor, a second redistributor and a third redistributor from top to bottom; a phase separation tank, where a bottom of the phase separation tank is in communication with a bottom of the absorption tower through the pipelines, and a top of the phase separation tank is in communication with the third inlet and the first inlet through the pipelines; a heat exchanger, where the heat exchanger is in communication with the bottom of the phase separation tank through a rich liquid pump, and the heat exchanger is in communication with the fourth inlet and the second inlet through the pipelines; and a desorption tower, where the desorption tower is connected with a reboiler, and the desorption tower is connected with the heat exchanger through the pipelines.

According to the multistage uniform temperature phase change absorption tower for capturing high-concentration carbon dioxide provided by the present disclosure, an upper layer of the phase separation tank is the light phase, a lower layer of the phase separation tank is the rich phase, the rich phase is in communication with the bottom of the absorption tower through the pipelines, the light phase is in communication with the third inlet and the first inlet through the pipelines, the light phase is connected with a light phase pump, and the light phase enters the third inlet and the first inlet through the light phase pump and the pipelines.

According to the multistage uniform temperature phase change absorption tower for capturing high-concentration carbon dioxide provided by the present disclosure, the fourth inlet is located between a top of the absorption tower and the I-stage packing layer, the third inlet is located between the I-stage packing layer and the II-stage packing layer, the second inlet is located between the II-stage packing layer and the III-stage packing layer, and the first inlet is located between the III-stage packing layer and the IV-stage packing layer.

According to the multistage uniform temperature phase change absorption tower for capturing high-concentration carbon dioxide provided by the present disclosure, the first redistributor is located below the I-stage packing layer, the second redistributor is located below the II-stage packing layer, and the third redistributor is located below the III-stage packing layer.

According to the multistage uniform temperature phase change absorption tower for capturing high-concentration carbon dioxide provided by the present disclosure, the rich phase is connected with the heat exchanger through the rich liquid pump.

According to the multistage uniform temperature phase change absorption tower for capturing high-concentration carbon dioxide provided by the present disclosure, the heat exchanger is in communication with a top of the desorption tower through the pipelines, the heat exchanger is in communication with a bottom of the desorption tower through the lean liquid pump, a rich phase is pumped by a lean liquid pump to a desorption tower for desorption, desorbed absorption liquid becomes lean liquid, and the lean liquid enters the absorption tower through pipelines via the fourth inlet and the second inlet.

According to the multistage uniform temperature phase change absorption tower for capturing high-concentration carbon dioxide provided by the present disclosure, a proportion of the lean liquid entering the fourth inlet ranges from 60% to 80%, and a proportion of the lean liquid entering the second inlet ranges from 20% to 40%.

According to the multistage uniform temperature phase change absorption tower for capturing high-concentration carbon dioxide provided by the present disclosure, a proportion of a light phase entering the third inlet ranges from 80% to 90%, and a proportion of the light phase entering the first inlet ranges from 20% to 10%.

According to the multistage uniform temperature phase change absorption tower for capturing high-concentration carbon dioxide provided by the present disclosure, a height of the I-stage packing layer ranges from 0.5 meters (m) to 2.5 m, a height of the II-stage packing layer ranges from 1.5 m to 3 m, a height of the III-stage packing layer ranges from 0.5 m to 2 m, and a height of the IV-stage packing layer ranges from 1.5 m to 3 m.

According to the multistage uniform temperature phase change absorption tower for capturing high-concentration carbon dioxide provided by the present disclosure, a height-to-diameter ratio of the absorption tower ranges from 10 to 50.

The present disclosure discloses the following technical effects:

Openings are made at specific positions between the packing layers, and a multistage split-flow process is adopted to replace an inter-stage cooling process. By adjusting the split-flow ratio, a uniform temperature distribution inside the entire absorption tower is achieved, thereby avoiding the occurrence of local hot spots. On one hand, adjusting the split-flow ratio may improve absorption performance, and on the other hand, adjusting the split-flow ratio may reduce the degradation of the absorbent and minimize organic amine loss.

### BRIEF DESCRIPTION OF THE DRAWING

In order to explain the embodiments of the present disclosure or the technical scheme in the prior art more clearly, the drawing needed in the embodiments will be briefly introduced below. Obviously, the drawing described below is only some embodiments of the present disclosure, and other drawings may be obtained according to the drawing without creative work for ordinary people in the field.

The FIGURE is a schematic diagram of the overall structure of the present disclosure.

### DETAILED DESCRIPTION OF THE EMBODIMENTS

The technical solutions in the embodiments of the present disclosure will be clearly and completely described below with reference to the accompanying drawing. Obviously, the described embodiments represent only a part of the embodiments of the present disclosure, not all of them. Based on the embodiments of the present disclosure, all other embodiments obtained by those of ordinary skill in the art without creative effort shall fall within the protection scope of the present disclosure.

To make the above objectives, features, and advantages of the present disclosure more comprehensible, the following provides a further detailed description of the present disclosure with reference to the accompanying drawing and specific implementations.

Existing technologies lack proper handling of the heat released during the absorption of carbon dioxide by absorbents. For example, the patent with publication number CN116036803A discloses an absorption tower for flue gas carbon dioxide capture. The absorption tower includes a tower bottom recirculation section, an absorption section, and a water washing section arranged sequentially along the flue gas flow direction. The tower bottom recirculation section includes a liquid distributor, a variable-diameter packing layer, an absorption tower bottom, a liquid divider, and a semi-rich liquid cooler. The absorption liquid in the absorption section sequentially enters the liquid distributor and the variable-diameter packing layer, then flows to the right side of the absorption tower bottom, where the semi-rich liquid in the absorption liquid is transported to the semi-rich liquid cooler for cooling before returning to the liquid distributor. Although the disclosure replaces the inter-stage cooling process with a tower bottom recirculation process, reducing storage tank equipment, the disclosure introduces a semi-rich liquid cooler, and introducing the semi-rich liquid cooler adds additional costs.

The patent with publication number CN118236819A discloses a gas-liquid redistributor for absorption towers, an absorption tower, and a method thereof. The gas-liquid redistributor for absorption towers includes a distribution tray and at least one distribution mixer. The outer sidewall of the distribution tray may tightly fit the inner sidewall of the absorption tower. The distribution tray is provided with at least one vent hole. The distribution mixer is arranged above the vent hole and covers the vent hole. The distribution mixer includes multiple sets of symmetrically intersecting inclined plates. The inclined plates are provided with multiple openings for dividing the flue gas passing through the distribution tray. Although the absorption tower improves the capture efficiency of harmful gases in the flue gas, the absorption tower is not considered that increasing the capture rate will also increase the heat release of the absorbent.

The patent with publication number CN113648805A discloses a dual-zone dual-circulation flue gas carbon dioxide absorption tower, including an absorption tower main body, a lower absorption packing layer, an upper absorption packing layer, a lower spray device, an upper spray device, an absorption tower demister, a first tower bottom, a second tower bottom, and an absorbent preparation tank. The absorption tower main body is divided into an upper absorption tower and a lower absorption tower. The lower absorption tower is provided with the lower absorption packing layer, and the lower spray device is arranged above the lower absorption packing layer. The upper absorption tower is provided with the upper absorption packing layer, and the upper spray device is arranged above the upper absorption packing layer. By increasing the liquid-gas ratio in the lower absorption tower, the disclosure may reduce the height of the absorption tower while ensuring the carbon dioxide capture rate in the lower layer. By increasing the absorbent concentration in the upper absorption tower, the absorption reaction intensity is enhanced, ensuring the carbon dioxide capture rate in the upper layer while effectively reducing the height of the absorption tower. Ultimately, a high carbon dioxide capture rate for the entire tower is achieved while effectively reducing the height of the absorption tower. However, while improving the capture rate, the hazards caused by the temperature rise of the absorbent are not considered.

To address the issue of heat release during the absorption of carbon dioxide by absorbents, the device adopts a multistage split-flow process to replace the inter-stage cooling process. By adjusting the split-flow ratio, a uniform temperature distribution inside the entire absorption tower is achieved. The specific content is as follows.

As shown in the FIGURE, the present disclosure provides a multistage uniform temperature phase change absorption tower for capturing high-concentration carbon dioxide, including: an absorption tower 1, where the absorption tower 1 is provided with multiple inlets, packing layers, and redistributors distributed from top to bottom, the inlets are sequentially a fourth inlet 104, a third inlet 103, a second inlet 102 and a first inlet 101 from top to bottom, the packing layers are sequentially an I-stage packing layer 105, a II-stage packing layer 106, a III-stage packing layer 107 and a IV-stage packing layer 108 from top to bottom, and the redistributors are sequentially a first redistributor 109, a second redistributor 110 and a third redistributor 111 from top to bottom; a phase separation tank 2, where a bottom of the phase separation tank 2 is in communication with a bottom of the absorption tower 1 through the pipelines, and a top of the phase separation tank 2 is in communication with the third inlet 103 and the first inlet 101 through the pipelines; a heat exchanger 4, where the heat exchanger 4 is in communication with the bottom of the phase separation tank 2 through a rich liquid pump 3, and the heat exchanger 4 is in communication with the fourth inlet 104 and the second inlet 102 through the pipelines; and a desorption tower 7, where the desorption tower 7 is connected with a reboiler 6, and the desorption tower 7 is connected with the heat exchanger 4 through the pipelines.

The absorption tower 1 is provided with fourth inlet 104, third inlet 103, second inlet 102, and first inlet 101 from top to bottom, controlling a certain proportion of lean liquid and light phase 201 to enter the tower. The packing layers are used to promote contact between the flue gas and the absorbent, improving CO₂ absorption efficiency. The redistributors are used to evenly distribute the liquid, ensuring uniform distribution of the absorbent in the packing layers and avoiding the formation of local hot spots. Without affecting the capture rate, openings are made at specific positions between the packing layers, and a multistage split-flow process is adopted to replace the inter-stage cooling process. By adjusting the split-flow ratio, a uniform temperature distribution inside the entire absorption tower 1 is achieved, avoiding local hot spots. Adjusting the split-flow ratio may improve absorption performance on one hand and reduce absorbent degradation and organic amine loss on the other.

Flue gas enters absorption tower 1 from the bottom, with high-concentration CO₂ ranging from 20% to 40% and gas velocity ranging from 0.2 meters per second (m/s) to 3 m/s. The phase change capture uses a liquid-liquid phase change absorbent, and the absorbent is located inside absorption tower 1.

Fourth inlet 104 is located between I-stage packing layer 105 and the tower top, used to introduce lean liquid, with a proportion ranging from 60% to 80%. Third inlet 103 is located between I-stage packing layer 105 and II-stage packing layer 106, used to introduce light phase 201, with a proportion ranging from 80% to 90%. Second inlet 102 is located between II-stage packing layer 106 and III-stage packing layer 107, used to introduce lean liquid, with a proportion ranging from 20% to 40%. First inlet 101 is located between III-stage packing layer 107 and IV-stage packing layer 108, used to introduce light phase 201, with a proportion ranging from 20% to 10%.

A height of the I-stage packing layer 105 ranges from 0.5 meters (m) to 2.5 m, a height of the II-stage packing layer 106 ranges from 1.5 m to 3 m, a height of the III-stage packing layer 107 ranges from 0.5 m to 2 m, and a height of the IV-stage packing layer 108 ranges from 1.5 m to 3 m. The height ranges of each packing layer differ, serving to promote contact between the flue gas and the absorbent and improve CO₂ absorption efficiency. The height-to-diameter ratio of absorption tower 1 ranges from 10 to 50.

The table below compares the height data of different packing layers in this embodiment and the temperature comparisons inside the tower after introducing different proportions of lean liquid and light phase. According to the data in the table, under the height ranges of the packing layers and the proportions of lean liquid and light phase addition set in this embodiment, a uniform temperature distribution inside the tower may be achieved.

| | | Height of | Height of | Height of | Height of | | | | | | | |
|---|---|---|---|---|---|---|---|---|---|---|---|---|
| | | I-stage | II-stage | III-stage | IV-stage | | | | | | Tower | |
| Gas | CO₂ | packing | packing | packing | packing | | | | | Tower top | bottom | |
| velocity | concentration | layer | layer | layer | layer | 101 | 102 | 103 | 104 | temperature | temperature | |
| 0.3 m/s | 25% | 2 m | 2.5 m | 2 m | 3 m | 10% | 40% | 90% | 60% | 50 degrees | 49.3° C. | Embodiment 1 |
| | | | | | | | | | | Celsius | | |
| | | | | | | | | | | (° C.) | | |
| | | 2.5 m | 2.5 m | 2.5 m | 2.5 m | 10% | 40% | 90% | 60% | 55.6° C. | 48.3° C. | Comparative |
| | | | | | | | | | | | | Embodiment 3 |
| | | 2 m | 2.5 m | 2 m | 3 m | 50% | 50% | 50% | 50% | 57° C. | 51.8° C. | Comparative |
| | | | | | | | | | | | | Embodiment 2 |
| | | 2 m | 2.5 m | 2 m | 3 m | 100% | 0 | 0 | 0 | 71° C. | 40° C. | Comparative |
| | | | | | | | | | | | | Embodiment 1 |

100% of 101 in Comparative Embodiment 1 means that both the lean liquid and light phase enter from 101. The proportions of 101 and 103 refer to the proportion of the light phase, while the proportions of 102 and 104 refer to the proportion of the lean liquid.

First redistributor 109 is located below I-stage packing layer 105, second redistributor 110 is located below II-stage packing layer 106, and third redistributor 111 is located below III-stage packing layer 107. The redistributors may be tray-type, trough-type, pipe-type, flower-type, or combined-type liquid redistributors, used to evenly distribute the liquid and avoid the formation of local hot spots inside absorption tower 1.

The upper layer in phase separation tank 2 is light phase 201, and the lower layer is rich phase 202. Light phase 201 refers to the absorbent solution separated in phase separation tank 2, containing less CO₂ and impurities. Light phase 201 is typically lighter than rich phase 202 (the absorbent solution containing more CO₂), so the light phase 201 floats on top in phase separation tank 2. The light phase 201 layer is connected through pipelines to light phase pump 8. The pumping end of light phase pump 8 is in communication with third inlet 103 and first inlet 101 through pipelines. Light phase 201 enters absorption tower 1 from third inlet 103 and first inlet 101. Third inlet 103 is located between I-stage packing layer 105 and II-stage packing layer 106, and first inlet 101 is located between III-stage packing layer 107 and IV-stage packing layer 108. This design helps introduce light phase 201 at different positions in the tower to regulate the temperature inside the tower and promote CO₂ absorption. The introduction of light phase 201 helps maintain temperature balance inside absorption tower I because the inlet temperature of the light phase 201 is lower, helping to absorb and transfer heat inside the tower, thereby avoiding local overheating. The inlet temperature of light phase 201 liquid is below 40° C., and the multistage uniform temperature absorption tower 1 may uniformly control the temperature of the entire absorption tower 1 below 50° C.

Absorption tower 1 is connected with phase separation tank 2 through rich liquid pipelines. This connection method allows the rich liquid after absorption (the absorbent solution with higher CO₂ concentration) to flow out from the bottom of absorption tower 1 and enter phase separation tank 2 for separation. The separated rich phase 202 is pumped to heat exchanger 4 through rich liquid pump 3. Heat exchanger 4 is in communication with the top of desorption tower 7 through pipelines. Desorption tower 7 is connected with reboiler 6, and the reboiler 6 provides heat to heat the rich liquid in desorption tower 7, promoting CO₂ desorption. Through desorption tower 7 and reboiler 6, the carbon dioxide in the rich liquid is released to form lean liquid that may be reused. The lean liquid completes the cooling process in desorption tower 7, and the desorption tower 7 includes a cooling stage. The regenerated lean liquid in desorption tower 7 is pumped to heat exchanger 4 through lean liquid pump 5, after which the lean liquid enters absorption tower 1 from fourth inlet 104 and second inlet 102. This is to introduce lean liquid at different positions in the tower to achieve uniform temperature distribution and improve absorption efficiency. Fourth inlet 104 is located near the tower top, and second inlet 102 is located between II-stage packing layer 106 and III-stage packing layer 107. This design helps form countercurrent contact and improve CO₂ absorption efficiency.

### Embodiment 1

The experiment introduces flue gas with a velocity of 0.3 m/s and 25% CO₂ concentration from the tower bottom. The gas and absorbent in the tower contacts countercurrently. The absorbent absorbing CO₂ separates into light phase 201 and rich phase 202 in phase separation tank 2. Rich phase 202 is pumped to desorption tower 7 for desorption. The desorbed absorption liquid becomes lean liquid, and the lean liquid enters absorption tower 1 from fourth inlet 104 and second inlet 102 at proportions of 60% and 40%, respectively. Light phase 201 is pumped to third inlet 103 and first inlet 101 at proportions of 90% and 10%, respectively. It is observed that the temperature inside the tower is relatively uniform.

### Comparative Embodiment 1

The experiment introduces flue gas with a velocity of 0.3 m/s and 25% CO₂ concentration from the tower bottom. The gas and absorbent in the tower contacts countercurrently. The absorbent absorbing CO₂ separates into light phase and rich phase in the phase separation tank. Rich phase is pumped to the desorption tower for desorption. The desorbed absorption liquid becomes lean liquid, and both the lean liquid and light phase are sent entirely to the tower top. It is clearly observed that the temperature at the tower top is the highest, gradually decreasing from top to bottom. The temperature at the tower top reaches 71° C., while the temperature at the tower bottom is around 40° C.

In the description of the present disclosure, it should be understood that the terms “longitudinal,” “transverse,” “upper,” “lower,” “front,” “rear,” “left,” “right,” “vertical,” “horizontal,” “top,” “bottom,” “inner,” “outer,” etc., indicate orientations or positional relationships based on those shown in the accompanying drawing. These terms are used only for case of describing the present disclosure and do not indicate or imply that the referred devices or elements must have specific orientations or be constructed and operated in specific orientations. Therefore, they should not be construed as limiting the present disclosure.

The above-described embodiments are merely illustrative of the optional implementations of the present disclosure and do not limit the scope of the present disclosure. Without departing from the spirit of the design of the present disclosure, various modifications and improvements made by those of ordinary skill in the art to the technical solutions of the present disclosure shall fall within the protection scope defined by the claims of the present disclosure.

What is claimed is:

1. A multistage uniform temperature phase change absorption tower for capturing high-concentration carbon dioxide, comprising:
an absorption tower, wherein the absorption tower is provided with a plurality of inlets, packing layers, and redistributors distributed from top to bottom, the inlets are sequentially a fourth inlet, a third inlet, a second inlet and a first inlet from top to bottom, wherein a rich phase is pumped by a lean liquid pump to a desorption tower for desorption, desorbed absorption liquid becomes lean liquid, the lean liquid enters the absorption tower through pipelines via the fourth inlet and the second inlet, a proportion of the lean liquid entering the fourth inlet ranges from 60% to 80%, a proportion of the lean liquid entering the second inlet ranges from 20% to 40%, a proportion of a light phase entering the third inlet ranges from 80% to 90%, and a proportion of the light phase entering the first inlet ranges from 20% to 10%;
wherein the packing layers are sequentially an I-stage packing layer, a II-stage packing layer, a III-stage packing layer and a IV-stage packing layer from top to bottom, and the redistributors are sequentially a first redistributor, a second redistributor and a third redistributor from top to bottom;
wherein a height of the I-stage packing layer ranges from 0.5 meters (m) to 2.5 m, a height of the II-stage packing layer ranges from 1.5 m to 3 m, a height of the III-stage packing layer ranges from 0.5 m to 2 m, and a height of the IV-stage packing layer ranges from 1.5 m to 3 m;
a phase separation tank, wherein a bottom of the phase separation tank is in communication with a bottom of the absorption tower through the pipelines, and a top of the phase separation tank is in communication with the third inlet and the first inlet through the pipelines;
a heat exchanger, wherein the heat exchanger is in communication with the bottom of the phase separation tank through a rich liquid pump, and the heat exchanger is in communication with the fourth inlet and the second inlet through the pipelines; and
the desorption tower, wherein the desorption tower is connected with a reboiler, and the desorption tower is connected with the heat exchanger through the pipelines.

2. The multistage uniform temperature phase change absorption tower for capturing high-concentration carbon dioxide according to claim 1, wherein an upper layer of the phase separation tank is the light phase, a lower layer of the phase separation tank is the rich phase, the rich phase is in communication with the bottom of the absorption tower through the pipelines, the light phase is in communication with the third inlet and the first inlet through the pipelines, the light phase is connected with a light phase pump, and the light phase enters the third inlet and the first inlet through the light phase pump and the pipelines.

3. The multistage uniform temperature phase change absorption tower for capturing high-concentration carbon dioxide according to claim 2, wherein the fourth inlet is located between a top of the absorption tower and the I-stage packing layer, the third inlet is located between the I-stage packing layer and the II-stage packing layer, the second inlet is located between the II-stage packing layer and the III-stage packing layer, and the first inlet is located between the III-stage packing layer and the IV-stage packing layer.

4. The multistage uniform temperature phase change absorption tower for capturing high-concentration carbon dioxide according to claim 3, wherein the first redistributor is located below the I-stage packing layer, the second redistributor is located below the II-stage packing layer, and the third redistributor is located below the III-stage packing layer.

5. The multistage uniform temperature phase change absorption tower for capturing high-concentration carbon dioxide according to claim 2, wherein the rich phase is connected with the heat exchanger through the rich liquid pump.

6. The multistage uniform temperature phase change absorption tower for capturing high-concentration carbon dioxide according to claim 5, wherein the heat exchanger is in communication with a top of the desorption tower through the pipelines, and the heat exchanger is in communication with a bottom of the desorption tower through the lean liquid pump.

7. The multistage uniform temperature phase change absorption tower for capturing high-concentration carbon dioxide according to claim 1, wherein a height-to-diameter ratio of the absorption tower ranges from 10 to 50.
